(19) United States
(12) Patent Application Publication
(10) Pub. No.: US 2016/0131103 A1
(43) Pub. Date: May 12, 2016

(54) MARINE TURBINE PIVOT SUPPORT

(71) Applicant: Jean Baptiste DREVET, Paris (FR)

(72) Inventor: Jean Baptiste DREVET, PARIS (FR)

(21) Appl. No.: 14/894,907

(22) PCT Filed: May 24, 2014
(86) PCT No.: PCT/EP2014/060751

§ 371 Date: Nov. 30, 2015

(30) Foreign Application Priority Data
May 31, 2013 (FR) 1355016

(51) Int. Cl. F03B 15/00; F03B 13/26; F03B 13/10; F03B 13/18

(52) U.S. Cl. CPC F03B 15/00; F03B 13/18; F03B 13/26; F03B 13/10

(57) ABSTRACT

A water current power generator having an energy capture assembly, a preferred energy capture axis, and a support for carrying the capture assembly. The generator has steering means for steering the capture assembly relative to the support, the steering means being arranged to steer the capture assembly by pivoting the capture assembly about at least one axis of the support, and to perform said steering in such a manner that when the capture assembly is immersed in a fluid flow presenting a flow direction and a given minimum flow speed, the preferred energy capture axis is substantially oriented parallel to the flow direction, the steering means also including resilient return means for returning the capture assembly towards a reference angular position of the capture assembly relative to the support.

The invention relates to the general field of water current power generators arranged to collect mechanical energy from a fluid flow.

### BACKGROUND OF THE INVENTION

By way of example, a water current power generator is known from patent WO 2010/012888 that is arranged to collect mechanical energy from a flow of fluid such as water.

The efficiency of such a generator depends to a large extent on its orientation relative to the flow direction of the fluid in which it is immersed.

### OBJECT OF THE INVENTION

An object of the invention is to provide a water current power generator that enables its energy capture assembly to be steered in the fluid flow.

### SUMMARY OF THE INVENTION

To this end, the invention provides a water current power generator comprising:
an energy capture assembly adapted to capture mechanical energy from a fluid flow, the capture assembly having a preferred energy capture axis such that the efficiency of mechanical energy capture by the capture assembly is at a maximum when the preferred energy capture axis extends parallel to a flow direction of fluid in which the capture assembly is immersed; the generator also including:
a support for carrying the capture assembly.

The generator of the invention is essentially characterized in that it includes steering means for steering the capture assembly relative to the support, the steering means being arranged to steer the capture assembly by pivoting the capture assembly about at least one axis of the support, and to perform said steering in such a manner that when the capture assembly is immersed in a fluid flow presenting a flow direction and a given minimum flow speed, the preferred energy capture axis is substantially oriented parallel to the flow direction, the steering means also including resilient return means for returning the capture assembly towards a reference angular position of the capture assembly relative to the support.

In order to understand the invention, the term “preferred energy capture axis oriented substantially parallel to the flow direction” should be understood as meaning that the preferred energy capture axis is parallel to the fluid flow direction to within plus or minus 20° and preferably plus or minus 5°. This limit to within ±20° is preferred when the generator is placed in a current at low speed, less than 0.5 meters per second (m/s). The limit to within ±5° is preferably selected when the generator is placed in a current at high speed, i.e. at a speed greater than 0.5 m/s. The preferred energy capture axis in the current is preferably steered by the drag forces on the generator and its support (which may include a vertical panel to increase the steering effect generated by drag forces). It should be observed that drag forces vary with the square of the speed of the current, and thus that the accuracy of steering increases with increasing speed of the current. It should be observed that when the current is flowing in a straight-line direction, the current is considered to be a laminar flow.

Because of the steering means of the invention, when the capture assembly is immersed in a laminar fluid flow that presents a straight-line flow direction with a speed that is greater than or equal to a given minimum flow speed, then the capture assembly is steered so as to occupy a direction in the flow for which the preferred energy capture axis of the assembly is substantially parallel to the flow direction.

The given minimum speed is selected to be the flow speed from which it is desired that the steering means should enable the capture assembly to be steered (or should steer it) relative to the flow direction in such a manner that the preferred energy capture axis is substantially parallel to the flow direction and consequently substantially parallel to the axis of the flow.

Below the given minimum flow speed, the steering means keep the capture assembly in its stationary reference position relative to the support, which angular reference position is independent of any flow direction.

The capture assembly is steered in the fluid flow by the steering means co-operating with the capture assembly so as to take account both of the direction of the flow and of the speed of the flow in order to perform steering. Thus, providing the speed of the flow is sufficient, the steering means steer the capture assembly so that its preferred energy capture axis lies in the flow direction even if the flow direction varies and/or reverses.

By steering the capture assembly into the flow direction, the steering means potentially optimize the quantity of mechanical energy that is captured from the current, in particular during stages in which the flow presents a speed greater than the given minimum speed and changes direction.

In certain circumstances, in particular when the fluid flow is associated with a tide that rises and falls in alternation, it has been observed that the change in the flow direction of the current is accompanied by a drop in its flow speed at the moment that the tidal direction reverses. Once the current has a stable flow direction once more, the flow speed also increases. By using resilient return means for returning the capture assembly towards a reference angular position relative to the support, the invention makes it possible to steer the capture assembly into the predetermined reference angular position as soon as the fluid flow speed drops below the predetermined minimum speed.

Ideally, the generator of the invention is installed in such a manner that the preferred energy capture axis of the capture assembly in the reference position relative to the support is aligned to be parallel with the stabilized flow direction that is well known for a given area of sea bed. This well-known flow direction is preferably the direction in which current becomes established at the beginning of a falling tide or at the beginning of a rising tide.

In a cycle involving a rising tide with current flowing in a rising tide direction, followed by a falling tide with current flowing in another direction that is a falling tide direction, the invention enables the capture assembly to be positioned in its reference position, e.g. corresponding to the falling tide direction, even before the speed of the falling tide current is sufficient to constrain the capture assembly to be steered into the falling tide direction.

Over a tide cycle, about one-fourth of the cycle time corresponds to slack water when the flow presents a speed:
that is insufficient for steering the capture assembly; and
but sufficient for enabling mechanical energy to be captured by the capture assembly providing it is properly oriented in the flow.

By means of the resilient return means, the invention enables the capture assembly to be steered so that it begins to capture energy from the falling tide flow as soon as the tide reverses.

If the generator of the invention is properly installed relative to the sea bed, its simple resilient means make it possible to increase the potential duration over which mechanical energy is captured during a rising/falling tide cycle.

For all of these reasons, the invention makes it possible overall to improve the energy capture efficiency over a tide cycle.

In a preferred embodiment of the invention, the steering means are arranged to steer the capture assembly relative to the flow direction as soon as the given minimum flow speed exceeds 0.4 m/s. In other words, the steering means are arranged to keep the capture assembly in the reference angular position so long as the flow speed is less than 0.4 m/s. Above that minimum speed, the steering means steer the capture assembly in the flow as a function of the flow direction.

In an embodiment of the invention, the generator includes means for generating a drag force when the assembly is immersed in the fluid flow, which drag force generator means are arranged in such a manner that the drag force generates torque on the steering means so as to cause them to steer the capture assembly so that a preferred energy capture axis extends substantially parallel to the flow direction.

These drag force generator means may comprise:
an element forming a vane of the capture assembly, such as the undulating diaphragm of the capture assembly described below; and/or
an element forming a vane of the steering means, such as a vane extending from the steering means parallel to the support axis.

In order to encourage steering of the capture assembly in the flow, it should be ensured that the steering means are placed so that the drag force generated on the capture assembly immersed in the flow generates torque about the support axis so as to steer the capture assembly to bring its preferred energy capture axis so that it is substantially parallel to the flow direction.

The invention also provides a method of using a generator in accordance with any embodiment of the invention, said generator further including anchor means for anchoring the support and arranged to enable the support to be anchored to a bed of a sea bottom and to prevent the support from turning relative to the sea bed on which it is anchored.

The method of the invention is essentially characterized in that it includes a step of anchoring the support of the generator on the sea bed in such a manner that when the capture assembly is in the reference angular position relative to the support, the preferred energy capture axis is then substantially parallel to a fluid flow direction corresponding to the main flow direction of the sea current during a rising tide and/or during a falling tide.

In order to understand the invention, the term “the preferred energy capture axis is substantially parallel to a fluid flow direction” means that the preferred capture axis is parallel to within plus or minus 20° of the flow direction. When the flow speed is sufficiently high, i.e. greater than the given minimum speed, the capture assembly is steered by the steering means so that the preferred energy capture axis is substantially parallel to a flow current direction. When the flow speed is less than the given flow speed, which is generally about 0.4 m/s, then the capture assembly is pivoted so that the capture assembly lies in its reference angular position relative to the support, with the preferred energy capture axis then being substantially parallel to the forthcoming main flow direction that corresponds to a flow at the beginning of a rising tide and/or of a falling tide.

The generator of the invention together with its resilient return means is particularly suitable for being installed in an environment that presents tidal currents that change in direction and in magnitude while describing a “current rose”.

For applications where currents change little in direction, such as ocean currents or river currents, these steering means may present resilient return means that have weaker resilient return characteristics. Thus, in certain embodiments, arrangements may be made to select the stiffness of the resilient return means and/or a pre-stress value of the resilient return means as a function of the types of current present at the location where the generator is installed. In a particular embodiment of the invention, adjustment means may be arranged to vary the resilient return characteristics such as the stiffness of the resilient means and/or a pre-stress force of the resilient means.

### BRIEF DESCRIPTION OF THE DRAWINGS

Other characteristics and advantages of the invention appear clearly from the following description made by way of non-limiting indication and with reference to the accompanying drawings, in which:

FIG. 1 is a perspective view of a water current power generator of the invention when immersed in a laminar fluid flow;

FIG. 2 shows the FIG. 1 generator without its undulating diaphragm forming part of the energy capture assembly;

FIG. 3 shows a portion of the energy capture assembly shown in FIG. 1, this portion serving firstly to carry the undulating diaphragm and secondly to be assembled on a steerable portion of the steering means;

FIG. 4 shows the support and the steering means of the FIG. 1 generator, the steering means being arranged to support the portion of the energy capture assembly shown in FIG. 3;

FIG. 5 shows a portion of the support and of the steering means of FIG. 1 seen in section of a plane containing the support axis;

FIG. 6 is a section view of the steering means of the generator of the invention, the section plane containing the support axis;

FIG. 7 is an exploded section view of the FIG. 6 steering means, the section plane containing the support axis;

FIG. 8 is an exploded perspective view of a portion of the steering means of the generator of the invention, this portion presenting resilient return means for returning the capture assembly relative to the support;

FIG. 9 is a perspective view of the portion of the FIG. 8 steering means when assembled; and

FIG. 10 shows the torque needed for steering the energy capture assembly as a function of a steering angle θ about an origin corresponding to the reference angular position of the capture assembly relative to the support.

### DETAILED DESCRIPTION OF THE INVENTION

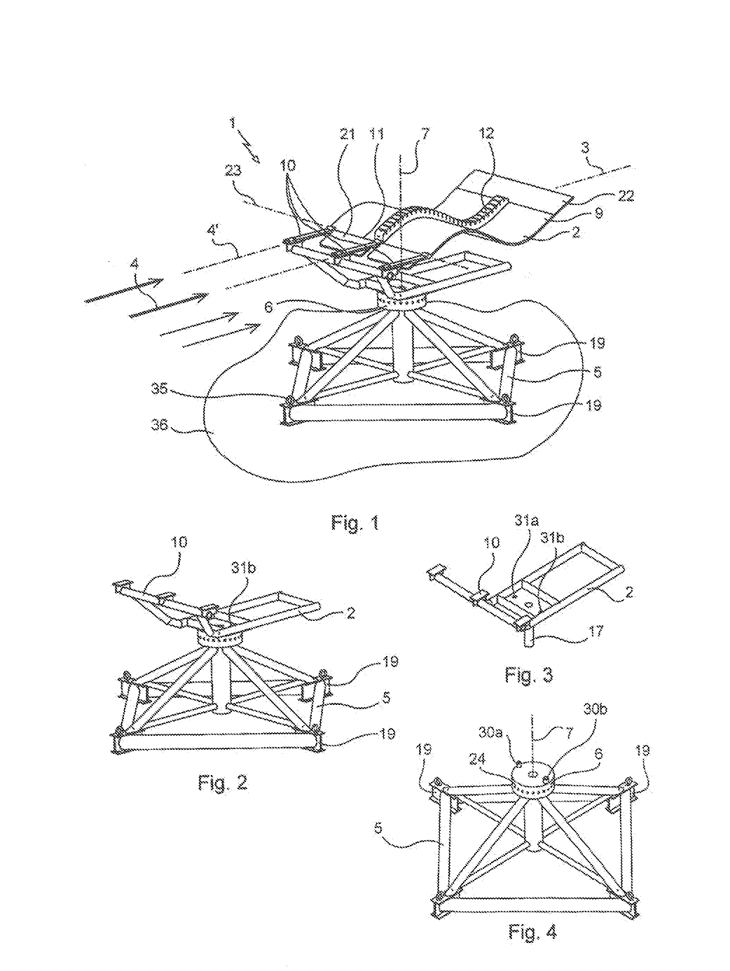

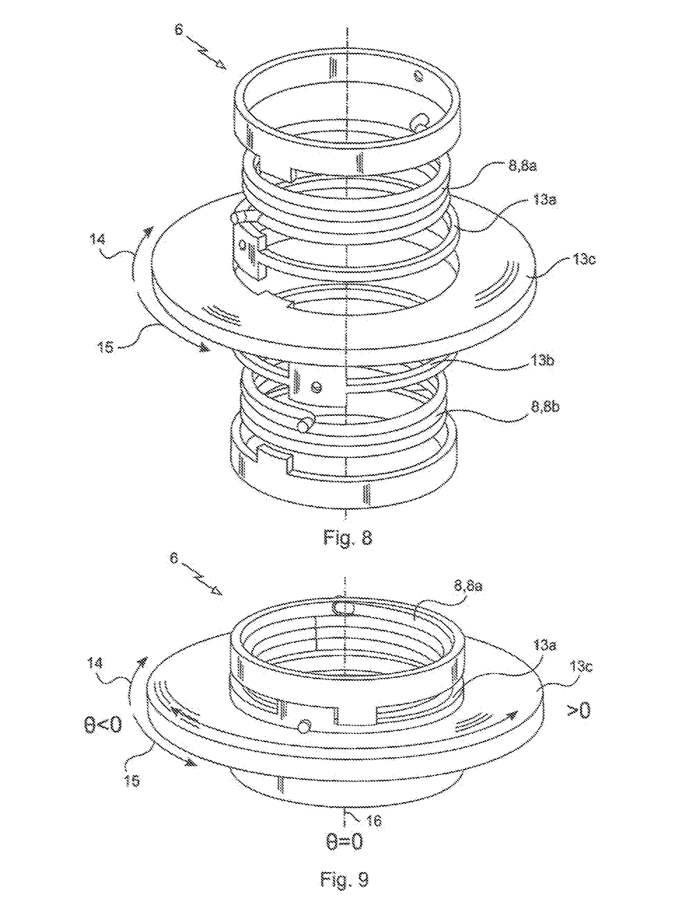

As mentioned above, the invention relates to a water current power generator 1 as shown in FIG. 1 and having component parts that are shown in FIGS. 2 to 9.

The generator 1 comprises an energy capture assembly 2 adapted to capture mechanical energy from a liquid fluid flow presenting a flow direction 4.

The capture assembly 2 has a preferred energy capture axis 3 such that the efficiency with which mechanical energy is captured from the flow by the capture assembly is at a maximum when this preferred energy capture axis 3 is parallel to the flow direction of the fluid 4 in which the capture assembly 2 is immersed.

The generator 1 also has a support 5 for carrying the capture assembly 2 and steering means 6 for steering the capture assembly 2 relative to the support 5. The steering means 6 are arranged to co-operate with the assembly 2 and to steer it by pivoting about a support axis 7 that is preferably vertically directed.

The steering means are connected to the support 5 and secondly to the capture assembly 2 in order to steer the assembly 2 immersed in a fluid flow that presents a flow direction 4 and a given minimum flow speed such that the preferred energy capture axis extends substantially parallel to the flow direction 4.

The steering means 6 also include resilient return means 8 for returning the capture assembly 2 towards a reference angular position 16 for the capture assembly 2 relative to the support 5.

Thus, by means of the invention, it is possible:
firstly to steer the capture assembly in the fluid flow as soon as the speed of the flow is sufficient, i.e. as soon as it is greater than the predetermined minimum speed, which is the speed from which it is considered that the flow does indeed present an effective or established flow direction; and
secondly to force the capture assembly to return to the reference position as soon as the flow speed is too slow for it to be considered that the flow direction 4 is indeed established.

In addition, since the resilient return means 8 are arranged to force the capture assembly 2 to be returned towards its reference position 16, they also oppose this capture assembly 2 moving away from its reference position 16 so long as the flow speed is less than the given and/or predetermined minimum flow speed.

To ensure that the capture assembly is steered, it is necessary for the flow direction 4 to be well established and to present a significant flow speed. In other words, so long as the capture assembly is subjected to a turbulent flow having no flow direction 4 that is well defined and/or of sufficient speed, the resilient means 8 keep the capture assembly 2 in the reference angular position 16 until the flow presents sufficient speed and a flow direction that is well established.

The given minimum speed is selected to be 0.4 m/s. By way of example, the generator may have mechanical or electromechanical adjustment means for adjusting the value of the minimum speed from which the preferred energy capture axis 3 is steered to be parallel with the flow direction.

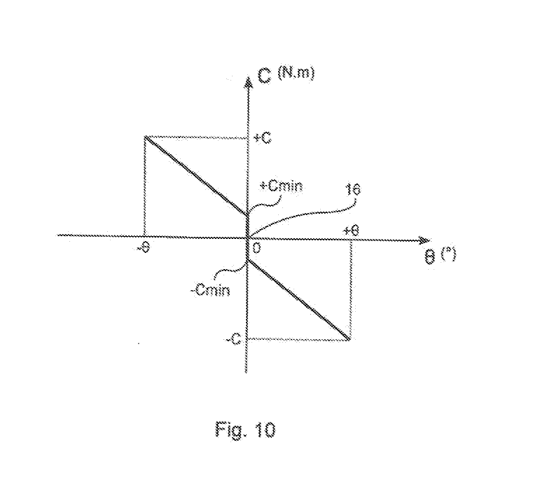

The steering means 6 are arranged so that as soon as the flow is laminar and exceeds the given minimum speed, then some minimum level of torque acts to cause the capture assembly to pivot away from its reference angular position. This minimum torque Cmin is shown in FIG. 10, where it can be seen that so long as the torque C exerted between the support 5 and the capture assembly 2 about the support axis 7 is not greater in absolute value than the absolute value of the predetermined minimum torque, Cmin, then the capture assembly 2 remains in its predetermined angular position 16 in which the preferred steering angle θ of the energy capture axis 3 relative to the predetermined angular position 16 is such that θ=0′.

When the torque C exerted between the support 5 and the capture assembly 2 about the support axis 7 becomes greater in absolute value than the absolute value of the predetermined minimum torque Cmin, then the capture assembly 2 begins to pivot about the support axis 7 away from its reference position 16.

As soon as the absolute value of the torque C becomes greater than the absolute value of the predetermined minimum torque Cmin, the steering angle θ varies in linear manner as a function of the torque C. It can be seen that this linear variation of the torque as a function of the angle θ is symmetrical on either side of the reference position 16.

The coefficient of linear variation of the torque C as a function of the angle θ in a first turning direction 14 of the assembly is a function of the stiffness specific to a first spring 8a forming part of the resilient means 8.

Likewise, the coefficient of linear variation of the torque C as a function of the angle θ in a second turning direction 15 of the assembly 2 is a function of the stiffness specific to a second spring 8b forming part of the resilient means 8.

As can be seen in FIG. 1, the energy capture assembly 2 has a diaphragm 9 arranged to undulate when it is immersed in the fluid flow. This undulation takes place in a travel direction of a diaphragm wave corresponding to the preferred energy capture axis 3. Such a diaphragm is itself known, e.g. from patent document WO 2010/012888. As can be seen in FIG. 1, the diaphragm may have at least one leading edge fin 21 connected to an upstream end 11 of the diaphragm that is to form its leading edge so as to constrain this upstream end 11 to pivot about a pivot axis 23 perpendicular to the upstream end 11. This leading edge fin 21 serves to encourage initiating undulating motion of the diaphragm 9 in the flow. Likewise, the diaphragm may have a trailing edge fin 22 connected to an upstream end of the diaphragm and arranged to form the diaphragm at its trailing edge to pivot about another axis passing through the trailing edge and parallel to the axis 23. The trailing edge fin 22 encourages the diaphragm to extend in the flow direction 4 of the current. These leading and trailing fins 21 and 22 serve to limit any tendency of the diaphragm to begin twisting about the preferred energy capture axis 3.

The capture assembly 2 includes an attachment part 10 of the diaphragm having an upstream end 11 of the diaphragm 9 attached thereto via flexible connections.

The diaphragm 9 can thus pivot at the location of this connection with the part 10 about a pivot axis 23 that is substantially perpendicular to the support axis 7. Under the effect of this pivoting about the axis 23, the diaphragm curves about rectilinear curvature axes parallel to the pivot axis 23. It is then found that the diaphragm 9 undulates in the flow, forming at all times a shape that is substantially sinusoidal. As can be seen in FIG. 1, the capture assembly may include limit means 50a, 50b for limiting the departure of the upstream end of the diaphragm from its downstream edge. These limit means 50a, 50b are arranged so that the diaphragm cannot become stretched into a plane and it keeps the upstream and downstream edges of the diaphragm spaced apart by a maximum distance that is less than the total length of the diaphragm. Thus, the diaphragm necessarily presents curvature in the flow direction of the current, thereby enhancing its undulation in the current. The limit means 50a and 50b are flexible connections placed on either side of the diaphragm and extending parallel to the side edges of the diaphragm. Each of these connections has one end fastened to the upstream edge and another end fastened to the downstream edge of the diaphragm.

The assembly 2 is coupled to a converter 12 for converting at least a fraction of the mechanical energy captured by the capture assembly 2 into electrical energy. In this example, the converter 12 is carried in full by the diaphragm 9 so as to generate electrical energy from an undulating movement of the diaphragm in the wave travel direction. Typically, the converter 12 is in the form of a plurality of permanent magnets and a plurality of coils that are connected to the diaphragm 9 in such a manner that during undulation of the diaphragm the permanent magnets are moved relative to the coils and induce electric currents in them.

These coils are electrically connected to conductors so that the currents induced in the coils are collected and delivered to an electricity distribution network.

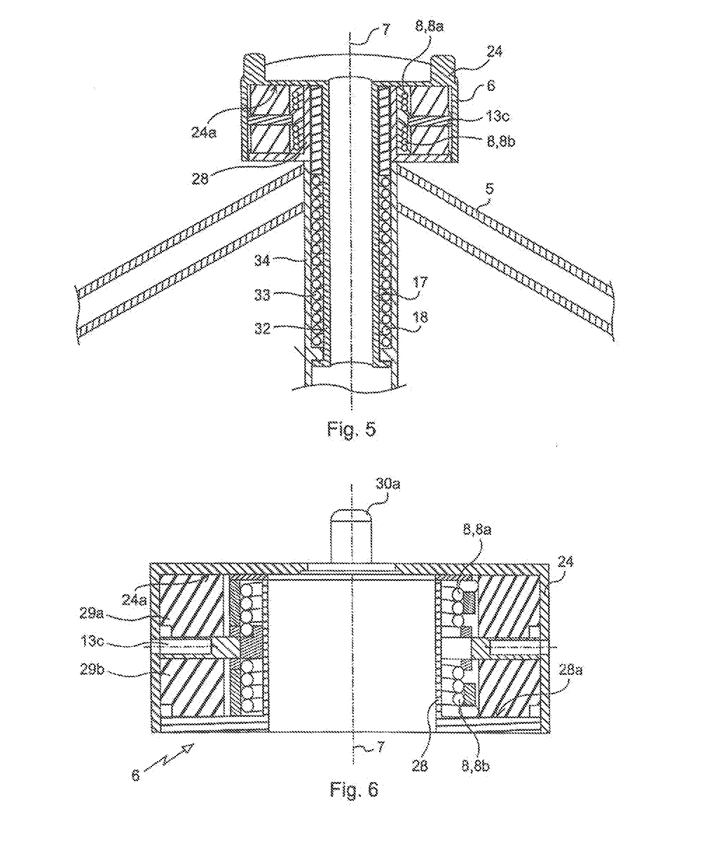

As mentioned above, the steering means shown in FIGS. 5, 6, 7, 8, and 9 have resilient return means 8 that, in this example, are constituted by first and second helical return springs 8a and 8b. These springs are incorporated in a rotary housing 24 of the steering means 6.

Each of these springs 8a, 8b is arranged to return said capture assembly 2 towards its reference angular position 16. Coupling means 13a and 13b for coupling these first and second springs 8a and 8b with the capture assembly 2 are formed in such a manner that, of these springs 8a and 8b:
it is only the first spring 8a that tends to return the capture assembly 2 towards its reference position 16 when it departs from the reference position 16 by turning through a steering angle θ about said support axis 7 in a first turning direction 14; and
it is only the second spring 8b that tends to return the capture assembly 2 towards its reference position 16 when it departs from this reference position 16 by turning about said support axis 7 in a second turning direction 15 opposite to said first turning direction 14.

Each of the first and second coupling means 13a and 13b is in the form of an annular ring having an angular abutment 25a for the first coupling means 13a and an angular abutment 25b for the second coupling means 13b.

The steering means 6 also present:
a third annular ring 13c constrained to turn with the capture assembly 2; and
fourth and fifth annular rings 26a and 26b constrained to turn with the support 5.

The third annular ring 13c presents angular abutments 27a and 27b. The abutment 27a of the third ring 13c is arranged to come into abutment against the angular abutment 25a of the ring 13a, referred to as the first coupling means 13a, when the capture assembly 2 is pivoted about the support axis 7 in a first turning direction 14 relative to the support 5.

The abutment 27b of the third ring 13c is arranged to come into abutment against the angular abutment 25b of the ring 13b, referred to as the second coupling means 13b, when the capture assembly 2 is pivoted about the support axis 7 in a second turning direction 15 relative to the support 5, this second turning direction 15 being opposite to the first turning direction 14.

Since the first return spring 8a presents one end 8a1 that is coupled to the ring 13a and another end 8a2 that is coupled to the fourth ring 26a, it is the first spring 8a that acts during turning in the first turning direction 14 from the reference angular position 16 to oppose the capture assembly moving away from its reference angular position 16. In this pivoting movement of the assembly 2 relative to the support 5 from the angular position 16 in the first turning direction 14, the second spring 8b is decoupled from the third ring 13c since the second means 13b present a second angular abutment 25c engaged with an angular abutment 26b1 formed on the fifth ring 26b that is stationary relative to the support. This angular abutment 26b1 is arranged to oppose pivoting of the second coupling means 13b beyond the reference position 16 in the first turning direction 14 relative to the support 5.

Since the second return spring 8b presents one end 8b1 that is coupled to the ring 13b and another end 8b2 that is coupled to the fifth ring 26b, it is the second spring 8b that acts during turning in the second turning direction 15 from the reference angular position 16 to oppose the capture assembly 2 moving away from its reference angular position 16. In this pivoting movement of the assembly 2 relative to the support 5 from the angular position 16 in the second turning direction 15, the first spring 8a is decoupled from the third ring 13c since the first means 13b present a second angular abutment 25d engaged with an angular abutment 26a1 formed on the fourth ring 26a that is likewise stationary relative to the support. This angular abutment 26a1 is arranged to oppose pivoting of the first coupling means 13a beyond the reference position 16 in the second turning direction 15 relative to the support 5.

Each of the rings 13a, 13b, 13c, 26a, and 26b, and each of the springs 8a and 8b is arranged around an internal annular tube 28 of the steering means, this tube 28 extending around the support axis 7 and being fixedly secured to the support 5. The fourth and fifth rings 26a and 26b are secured to the tube 28 so as to be constrained in rotation relative to the support 5. The fourth ring is secured to the tube 28 by means of a washer 40.

The rotary housing 24 of the steering means 6 that extends around the rings 13a, 13b, 13c, 26a, and 26b and around each of the springs 8a and 8b is constrained firstly to turn with the third ring 13c and secondly with the capture assembly 2, about the turning axis 7.

The third ring 13c is secured to the housing 24 via peripheral screws that pass through holes 41 in the housing and that penetrate into the periphery of the third ring 13c.

The rotary housing 24 and the tube 28 form an outer covering of the steering means 6, enabling the springs 8a and 8b to be protected against attacks coming from outside the steering means 6.

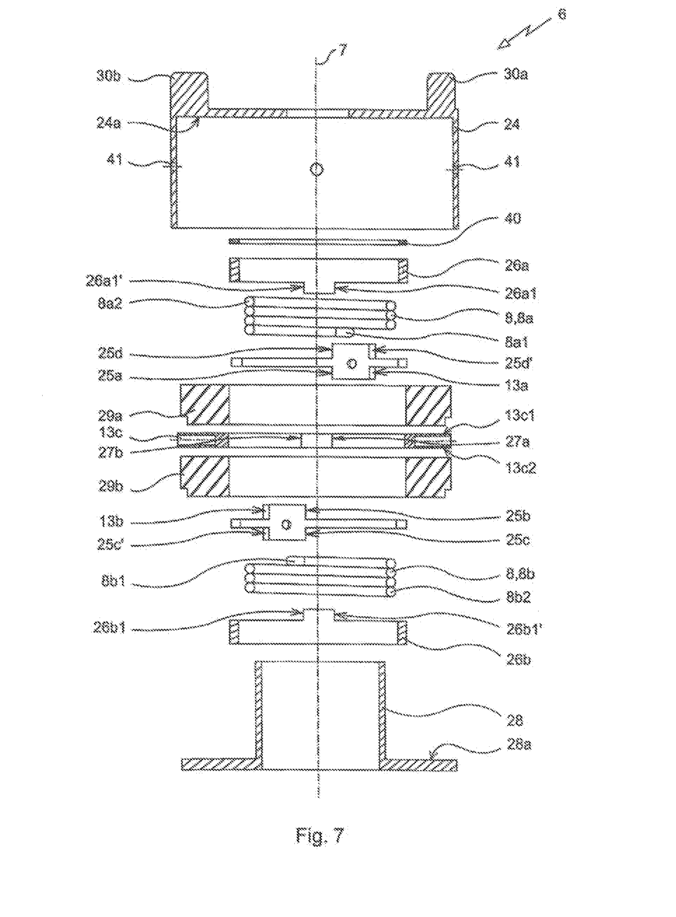

Finally, as can be seen in FIG. 7, the steering means present sixth and seventh friction rings 29a and 29b each of which is arranged around the support axis and consequently around the tube 8.

The friction sixth ring 29a is arranged axially between the inside face 24a of the rotary housing 24 and a first face 13c1 of the third ring 13c so as to limit axial friction (i.e. along the axis 7) between the ring 13c and the housing 24 during pivoting of the capture assembly 2 relative to the support 5.

The friction seventh ring 29b is arranged axially between an internal axial face 28a of the tube 28 and a second face 13c2 of the third ring 13c so as to limit axial friction between the ring 13c and the tube 28 during pivoting of the capture assembly 2 relative to the support 5.

In order to constrain the housing 24 in rotation with the capture assembly 2, use is made of studs 30a and 30b formed on the outside of the housing 24, these studs 30a and 30b being arranged to engage in respective complementary recesses 31a and 31b formed in a rigid face of the capture assembly 2. Clamping screws are provided to press the rigid face of the capture assembly 2 against the housing 24. Thus, the steering means 6 are assembled with the capture assembly merely by inserting the studs 30a, 30b into the complementary recesses 31a, 31b, and then clamping the capture assembly 2 against the housing 24 by using the screws. The studs may be positioned so as to constitute keying means allowing only one possible assembly position between the steering means 6 and the capture assembly 2. This avoids the preferred capture axis being wrongly oriented in the marine environment in which the support 5 is secured and steered. This greatly facilitates maintenance of the generator, for example when the capture assembly 2 is removed for maintenance purposes.

Ideally, the steering means 6 are arranged to limit turning of the capture assembly 2 relative to the support to no more than 180° about the reference angular position 16. For this purpose, the ring 13a presents a third abutment 25d′ arranged to come into abutment against a second abutment 26a1′ when the assembly has pivoted through about 170° to 180° from its reference angular position in said first turning direction 14. Likewise, the ring 13b presents a third abutment 25c′ arranged to come into abutment against a second abutment 26b1′ when the assembly has pivoted through about 170° to 180° from its reference angular position 16 in said second turning direction 15.

By being embodied in this way, the steering means can perform equivalent steering in both steering directions 14 and 15, while limiting twisting and damaging of the springs 8a and 8b.

As shown in FIG. 5, the generator may present means 32 for providing guidance in translation, which are constituted in this example by a tube securely assembled to the housing 24 and extending from the inside face 24a of the housing 24 along the support axis 7 towards the support 5. This tube 32 secured to the housing 24 passes inside the tube 28 that is secured to the support 5.

These means 32 for providing guidance in translation include means 33 for resiliently suspending the capture assembly 2 relative to the support 5. In this example, these resilient suspension means 33 comprise a compression spring extending outside the tube 32 and inside a tube 34 forming part of the support 5, and extending along the axis 7. The compression spring tends to move the housing 24 away from the tube 28 so as to limit the axial forces on either side of the third ring 13c, thereby limiting friction that might oppose turning of the capture assembly 2 relative to the support 5.

As can be seen in particular in FIG. 1, the generator also includes anchor means 35 for anchoring the support 5 that are arranged so as to enable the support 5 to be anchored to the bed 36 of a sea bottom and prevent the support 5 from turning relative to the sea bed 36 on which it is anchored.

These anchor means 35 may comprise no more than rigid means pushed into the sea bed 36, as shown in FIG. 1.

Alternatively, in an embodiment that is not shown, if the support is a support having floats, then the anchor means 35 may comprise flexible lines that are firstly securely connected to the sea bed 36 and secondly to the floating support so as to prevent it being able to pivot relative to the sea bed. Under all circumstances, the anchor means are arranged to prevent the support being able to pivot relative to the sea bed 36 about a vertical axis extending from the sea bed. This thus enables the reference position 16 to be oriented in a fixed direction relative to the sea bed 36.

1. A water current power generator comprising an energy capture assembly adapted to capture mechanical energy from a fluid flow, the capture assembly having a preferred energy capture axis such that the efficiency of mechanical energy capture by the capture assembly is at a maximum when the preferred energy capture axis extends parallel to a flow direction of fluid in which the capture assembly is immersed, the generator also having a support for carrying the capture assembly, the generator being characterized in that it includes steering means for steering the capture assembly relative to the support, the steering means being arranged to steer the capture assembly by pivoting the capture assembly about at least one axis of the support, and to perform said steering in such a manner that when the capture assembly is immersed in a fluid flow presenting a flow direction and a given minimum flow speed, the preferred energy capture axis is substantially oriented parallel to the flow direction, the steering means also including resilient return means for returning the capture assembly towards a reference angular position of the capture assembly relative to the support.

2. The generator according to claim 1, wherein the steering means are arranged to perform said steering as soon as the given minimum flow speed exceeds 0.4 m/s.

3. The generator according to claim 1, wherein the energy capture assembly comprises:
a diaphragm arranged so that when it is immersed in a fluid flow, it undulates in a travel direction of a diaphragm wave that corresponds to the preferred energy capture axis; and
an attachment part of the diaphragm having at least an upstream end of the diaphragm attached thereto.

4. The generator according to claim 1, wherein the mechanical energy capture assembly is coupled to a converter suitable for converting at least a fraction of the mechanical energy captured by the capture assembly into electrical energy.

5. The generator according to claim 4, wherein said converter is carried in full by the diaphragm so as to generate electrical energy from an undulating motion of the diaphragm in the wave travel direction along the diaphragm.

6. The generator according to claim 1, wherein the resilient return means comprise first and second return springs, each arranged to return said capture assembly into its reference angular position, the generator further including coupling means for coupling these first and second springs with the capture assembly, the coupling means being such that:
it is the first spring that tends to return the capture assembly towards its reference position when it has departed from the reference position by turning about said support axis in a first turning direction; and
it is the second spring that tends to return the capture assembly towards its reference position when it has departed from the reference position by turning about said support axis in a second turning direction contrary to said first turning direction.

7. The generator according to claim 6, wherein the coupling means are arranged to:
decouple the second spring from the capture assembly when the first spring is tending to return the capture assembly towards its reference position; and
decouple the first spring from the capture assembly when the second spring is tending to return the capture assembly towards its reference position.

8. The generator according to claim 1, further including means for providing the capture assembly with guidance for movement in translation relative to the support, this guidance for movement in translation taking place along said axis of the support, these means for providing guidance in translation including resilient suspension means for suspending the capture assembly relative to the support.

9. The method of using a generator according to claim 1, said generator further including anchor means for anchoring the support and arranged to enable the support to be anchored to a bed of a sea bottom and to prevent the support from turning relative to the sea bed on which it is anchored, the method including a step of anchoring the support of the generator on the sea bed in such a manner that when the capture assembly is in the reference angular position relative to the support, the preferred energy capture axis is then substantially parallel to a fluid flow direction corresponding to a main flow direction of the sea current during a rising tide and/or during a falling tide.
